(19) United States
(12) Patent Application Publication
(10) Pub. No.: US 2015/0244810 A1
(43) Pub. Date: Aug. 27, 2015

(54) COMMUNICATION APPARATUS AND NETWORK CONNECTION METHOD

(71) Applicant: Mitsubishi Electric Corporation, Tokyo (JP)

(72) Inventor: Yuya Takatsuka, Tokyo (JP)

(73) Assignee: Mitsubishi Electric Corporation, Tokyo (JP)

(21) Appl. No.: 14/417,908

(22) PCT Filed: Jul. 16, 2013
(86) PCT No.: PCT/JP2013/069275

§ 371 Date: Jan. 28, 2015

(30) Foreign Application Priority Data
Aug. 29, 2012 (JP) 2012-188942

(51) Int. Cl. H04L 29/08

(52) U.S. Cl. CPC H04L 67/141; H04L 67/143

(57) ABSTRACT

A communication apparatus that, when a device connects to an external network via another device, is capable of reducing the user's workload when connecting. The apparatus includes: a WLAN control unit that uses a WLAN to communicate with a WLAN STA device that communicates with an external network; a BT control unit that uses BT to communicate with a BT device capable of communicating with the external network; a connection history DB that stores therein information on connections to the BT devices and the order of priority for connecting to the BT devices; and a connection management unit that refers to the connection history DB. The communication apparatus connects to the WLAN STA device and to the BT device, and enables the WLAN STA device to communicate with the external network via the own apparatus and the BT device.

### FIELD

The present invention relates to a communication apparatus that connects to an external network via another device.

### BACKGROUND

In the conventional arts, it is assumed that most wireless LAN (WLAN: Wireless Local Area Network) APs (Access Points) are set up inside homes. The AP connects to a single always-connected line (for example, FTTH (Fiber To The Home) or ADSL (Asymmetric Digital Subscriber Line)) via a modem or the like. When a WLAN STA (Station) connects to the AP, the AP provides communication by using the backbone circuit that is connected to the AP.

In recent years, Aps, for which it is assumed they will be used outside the home (for example, a mobile router and the like), have become more widespread. The AP has a SIM (Subscriber Identity Module) card for connecting to a cellular network circuit (for example, 3G or LTE (Long Term Evolution)) inserted therein. When the STA connects to the AP, the AP provides communication by using the cellular network circuit.

Specifically, a technique has been disclosed in Patent Literature 1 mentioned below, in which a mobile phone that can be connected to the Internet connects to a host device by using Bluetooth®, a WLAN, or the like in order to provide an Internet connection and a host-to-host connection for the host device. Further, a technique has been proposed in Patent Literature 2 mentioned below in which a mobile phone is equipped with a wireless LAN function and a router function; and a router unit analyzes transmission data so as to determine whether to connect to the Internet.

With an AP for which it is assumed it will be used outside the home, the AP itself connects directly to an external network (for example, the Internet) and therefore is capable of directly controlling a connection to the external network depending on the connection of the STA to the AP. Consequently, the user does not need to operate the AP. Moreover, with the techniques described in Patent Literatures 1 and 2 mentioned below, a mobile phone connects directly to an external network and therefore there is neither need to perform a connection process to a device other than the STA nor to set network settings for a device connected to the mobile phone.

### CITATION LIST

### Patent Literatures

Patent Literature 1: Japanese Patent Application Laid-open No. 2007-104306

Patent Literature 2: Japanese Patent Application Laid-open No. 2005-217994

### SUMMARY

### Technical Problem

However, with the above conventional techniques, in a case where an AP (a communication apparatus) connects to another device that provides a connection to an external network by means of Bluetooth®, a USB (Universal Serial Bus), or the like, and further connects to an external network via another device connected to the AP, there is a problem in that the user needs to perform certain functions in order to connect the AP to the another device.

The present invention has been achieved to solve the above problems, and an objective of the present invention is to provide a communication apparatus that, when a device is to be connected to an external network via an apparatus to which the device belongs as well as another device, is capable of reducing the user's workload during the connecting.

### Solution to Problem

To solve the problem and objective, the present invention relates to a communication apparatus that includes: a first communication-control unit that uses a first communication mode to communicate with a first communication device that is to communicate with an external network; a second communication-control unit that uses a second communication mode to communicate with a second communication device that is capable of communicating with the external network; a connection-history storage unit that stores therein information on a connection to the second communication device and order of priority for connecting to the second communication device; and a connection management unit that refers to the connection-history storage unit to manage a connection to the first communication device and a connection to the second communication device. The communication apparatus connects to the first communication device and to the second communication device, and enables the first communication device to communicate with the external network via the own apparatus and the second communication device.

### Advantageous Effects of Invention

According to the present invention, the communication apparatus can reduce, when a device connects to an external network via an apparatus to which the device belongs and connects to another device, the user's workload during the connecting.

### BRIEF DESCRIPTION OF DRAWINGS

FIG. 1 illustrates a configuration example of a communication network according to a first embodiment.

FIG. 2 illustrates a configuration example of an AP.

FIG. 3 is a sequence diagram illustrating a network connection process according to the first embodiment.

FIG. 4 illustrates a registration example of information registered in a connection history DB according to the first embodiment.

FIG. 5 illustrates a configuration example of a communication network according to a second embodiment.

FIG. 6 is a sequence diagram illustrating a network connection process according to the second embodiment.

FIG. 7 illustrates a registration example of information registered in a connection history DB according to the second embodiment.

FIG. 8 is a sequence diagram illustrating a network connection process according to a third embodiment.

### DESCRIPTION OF EMBODIMENTS

Exemplary embodiments of a communication apparatus according to the present invention will be described below in detail with reference to the accompanying drawings. The present invention is not limited to the embodiments.

### First Embodiment

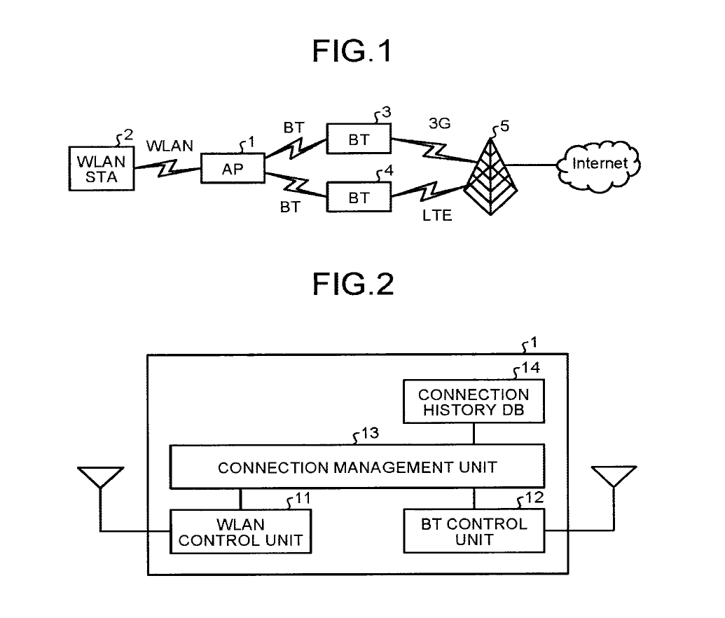

FIG. 1 illustrates a configuration example of a communication network according to the present embodiment. The communication network includes an AP (Access Point) 1, a WLAN (Wireless Local Area Network) STA (Station) 2, BTs (Bluetooth) 3 and 4, and a base station 5.

The AP 1 is a communication apparatus that has a

WLAN-AP function and a BT function. The AP 1 connects to the BTs 3 and 4 that provide the function of connecting to an external network via the ET, and provide the function of connecting an external network to the WLAN STA 2 that connects to the AP 1. For example, the AP 1 is a mobile router, a PC (personal computer), or an in-vehicle device, but is not limited thereto.

The WLAN STA 2 is a WLAN STA device equipped with a WLAN function and is a first communication device that desires to communicate with an external network. For example, the WLAN STA 2 is a PC, a Smartphone, or a tablet device, but is not limited thereto.

The BTs 3 and 4 are BT devices that have the BT function and are second communication devices that are capable of communicating with the external network via the base station 5. The BTs 3 and 4 are equipped with a profile that provides the function of connecting to the external network, such as a DUN (Dial-up Networking Profile) or a PAN (Personal Area Networking Profile). For example, the BTs 3 and 4 are mobile phones, but are not limited thereto.

The base station 5 is a mobile-phone base station, to which the BTs 3 and 4 or other devices connect. The base station 5 connects to the Internet, which is an external network. In FIG. 1, the base station 5 connects to the BT 3 over the 3G and connects to the BT 4 over the LTE as an example, but is not limited thereto. For example, the base station 5 can use WiMAX to connect to the BTs 3 and 4.

In FIG. 1, the communication network is configured from one WLAN STA device (the WLAN STA 2) and two BT devices (the BTs 3 and 4). However, there can be a plurality of WLAN STA devices and a plurality of BT devices in the communication network.

Next, the configuration of the AP 1 is described. FIG. 2 illustrates a configuration example of the AP 1. The AP 1 includes a WLAN control unit 11, a BT control unit 12, a connection management unit 13, and a connection history database (DB) 14.

The WEAN control unit 11 executes control of WLAN communication. In the present embodiment, the WLAN operates as an AP. The basic operation of the WLAN follows the “IEEE, “IEEE Std IEEE 802.11-2007”, 12 Jun. 2007”.

However, the WLAN is not particularly limited thereto as long as it can be connected to the WLAN STA 2 illustrated in FIG. 1.

The BT control unit 12 executes control of BT communication. The BT according to the present embodiment is equipped with at least one profile that provides the function of connecting to an external network, such as the DUN or PAN. The basic operation of BT follows “Bluetooth, “Specification of Bluetooth System Covered Core Package Version: 4.0”, 30 Jun. 2010”. However, the version of BT and the like are not particularly limited thereto as long as BT can be connected to the BTs 3 and 4 illustrated in FIG. 1.

The connection management unit 13 manages WLAN communication and BT communication and calls out necessary information from the connection history DB 14 so as to manage each connection.

The connection history DB 14 is a storage unit that stores therein the following: device information on an STA, a BT, and the like to which the AP 1 has connected previously; information required for a connection, such as a password; setting-value information to be used for a BT device to connect to a network; and other information.

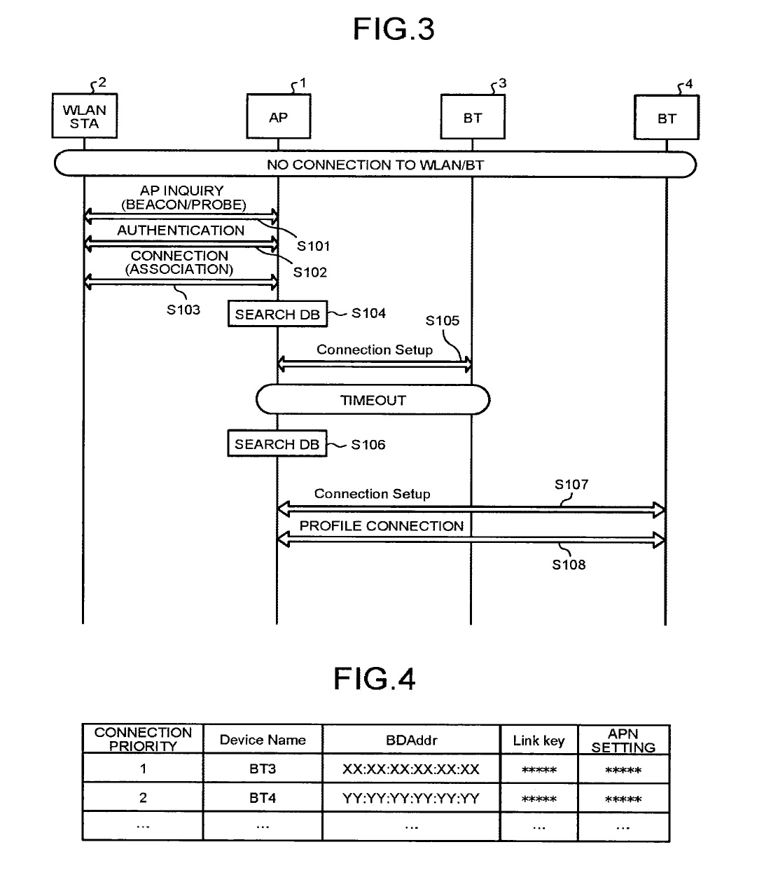

Next, a network connection process for the AP 1 according to the present embodiment is described. FIG. 3 is a sequence diagram illustrating the network connection process according to the present embodiment. In the initial state illustrated in FIG. 3, it is assumed that the AP 1, and the BTs 3 and 4 have already been paired; information, such as a BDAddr (Bluetooth Device Address), a Link key, and an APN (Access Point Network) setting, has been registered in the connection history DB 14; and connection priorities has been given to each BT device.

FIG. 4 illustrates a registration example of information registered in the connection history DB 14 according to the present embodiment. FIG. 4 illustrates a state where the DT 3 has been registered as connection priority 1, the DT 4 has been registered as connection priority 2, and their respective BDAddrs, Link keys, and APN settings have also been registered.

In the initial state in FIG. 3, it is assumed that connections of the AP 1 to the WLAN STA 2, and the BTs 3 and 4 are not established.

A specific network connection process is described below. First, the WLAN STA 2 that starts a connection to an external network inquires about a peripheral AP by receiving a Beacon transmitted from the AP 1 or by transmitting a Probe Request to the AP 1 (Step S101).

The WLAN STA 2, having decided to connect to the AP 1 as a result of the inquiry at Step S101, performs an authentication process (Step S102) and a connection process (Step S103) to establish a connection between the WLAN STA 2 and the AP 1. The detailed processes at Steps S101 to S103 are the same as those described in the IEEE 802.11 standards.

In the AP 1, having established a connection to the WLAN STA 2, the connection management unit 13 confirms whether there is a connection to an external network. When the AP 1 is connected to an external network, the connection management unit 13 uses the established connection to provide a connection to the external network for the WLAN STA 2. Because in this example the AP 1 is in a state where there is not a connection to the external network, the connection management unit 13 searches for a connecting BT device in the connection history DB 14 (Step S104). In the AP 1, the connection management unit 13 attempts to connect to a BT device in the order of connection priority and accordingly selects the BT 3 as the first connection target.

In the AP 1, the connection management unit 13 starts connecting to the BT 3 selected at Step S104 by using the BT control unit 12 (Step S105). The connection management unit 13 obtains the BDAddr, the Link key, and other information, which are required for the connection, from the connection history DB 14.

In this example, the BT function of the BT 3 is OFF, and therefore the connection process is assumed to have failed. In this case, a timeout occurs in the connection process, and the connection management unit 13 searches for a BT device to be the next connection option in the connection history DB 14. The connection process fails also when the BT 3 is not within communication range or when power is turned off. Further, the connection process fails also when a profile connection fails because a BT device is not compatible with the DUN or PAN.

The connection management unit 13 in the AP 1 searches for the next connecting BT device in the connection history DB 14 in the same manner as Step S104 (Step S106). In the AP 1, the connection management unit 13 attempts to sequentially connect to a BT device with the second highest connection priority after the BT 3 and accordingly selects the BT 4 as a second connection target.

In the AP 1, the connection management unit 13 starts connecting to the BT 4 selected at Step S106 by using the BT control unit 12 in the same manner as Step S105 (Step S107). In this example, the AP 1 is assumed to have completed the connection to the BT 4.

In the AP 1, the connection management unit 13 executes a profile connection with the BT 4 connected to the AP 1 via the BT control unit 12 (Step S108). The connecting profile is the DUN, PAN, or the like that provides a connection to an external network. The connection management unit 13 obtains information required for a network connection from the connection history DB 14.

The AP 1 connects to the WLAN STA 2 and to the BT 4 that is capable of communicating with the external network and is therefore capable of providing the WLAN STA 2 with communication with the external network via the apparatus it belongs to and the BT 4. The WLAN STA 2 can communicate with the external network via the communication apparatus and the BT 4.

As an example, the completion of a connection between the WLAN STA 2 and the AP 1 is used as a trigger to start connecting the AP 1 to a BT device. However, the present invention is not limited thereto. For example, the transmission and reception of the message during the authentication process or the connection process can be used as a trigger to start connecting the AP 1 to the BT device, or when an Internet connection request from a browser or the like is issued, as a trigger for the AP 1 and the BT device to start connecting to each other.

When the connection of the AP 1 and the BT device is completed and only the profile connection has not yet been executed, it is possible to omit the process at Step S107.

In the present embodiment, a case has been described where there is not a connection between the AP 1 and a BT device in the initial state. However, when there is a connection of the AP 1 and a BT device, the AP 1 can treat the connected BT device as a device with the highest connection priority. When the profiles are not compatible with each other, it is also possible for the connection management unit 13 in the AP 1 to search in the connection history DB 14.

The connection priority assigned to a BT device can be set in advance by a user, or it can be automatically determined and set by the AP 1 by registering the fee structure (such as a fixed fee or on an as-used basis) and the line information (such as 3G, LTE, or WiMAX). By registering the profile information supported by a BT device in the connection history DB 14, it is also possible to transmit a connection request only to a BT device that supports the DUN or PAN.

When a user operation such as inputting a PIN code occurs in a case, for example, where the Link key is deleted in a connection-target BT device, then the AP 1 can cancel the connection and select the next connection-target BT device.

The AP 1 can store in advance in a DB the APN setting and other information required for connecting to an external network. This also makes it possible to automatically perform the APN setting suitable for each carrier on the basis of operator information obtained from an AT command or the like.

In the present embodiment, a BT-connected mobile phone has been described as an example of a device that provides a connection to an external network (hereinafter, “external-network connection device”). However, other connection modes such as a USB and a WLAN are also applicable to a mobile phone.

As described above, according to the present embodiment, in the network configuration in which an AP connects to an external network via another device, a connection of a WLAN STA device and the AP is used as a trigger to automatically connect the AP to an external-network connection device. Therefore, a user does not need to perform a process to connect the AP to the external-network connection device in order for the WLAN STA device to communicate with the external network; and thus the user's workload during connection can be reduced.

By setting the connection priority in the AP, it is possible to give the connecting devices the user prefers a higher connection priority. As the AP sets connection priority automatically on the basis of the fee structure, the communication speed, and the like, it is therefore possible to connect to an optimum external-network connection device.

### Second Embodiment

In the present embodiment, a case where two WLAN STAs are provided is described. The parts different from those in the first embodiment are described here.

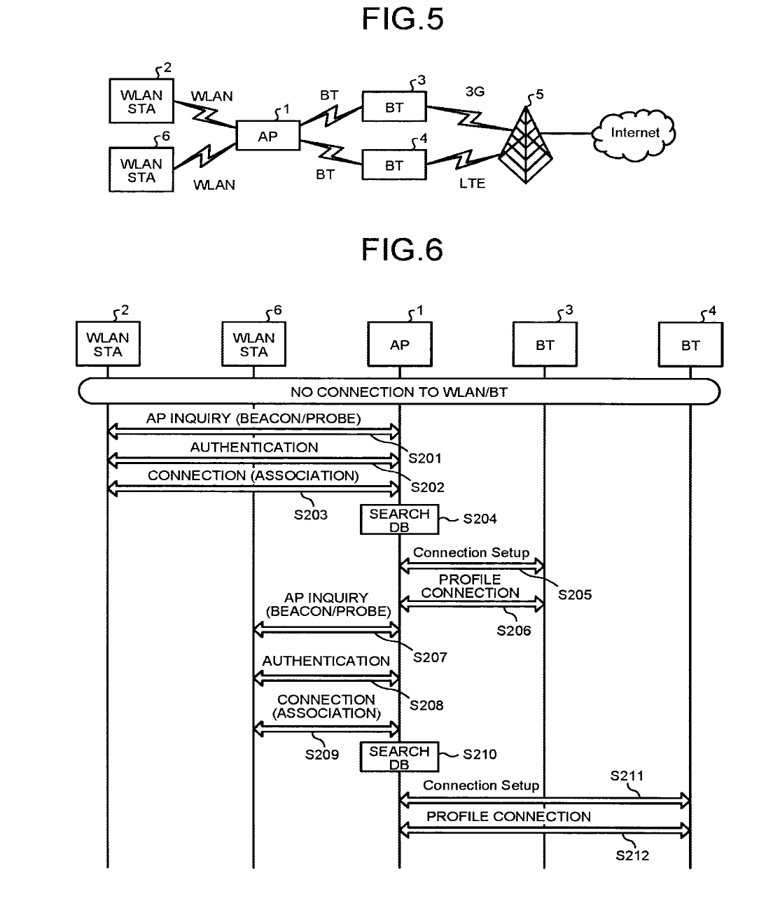

FIG. 5 illustrates a configuration example of a communication network according to the present embodiment. When compared with the communication network in FIG. 1, a WLAN STA 6 is added. While the AP 1 has the same configuration as in the first embodiment (see FIG. 2), the item “list of WLAN STAs”, which are permitted to connect to certain BT devices, is added to the connection history DB 14 according to the present embodiment.

Next, a network connection process in the AP 1 according to the present embodiment is described. FIG. 6 is a sequence diagram illustrating the network connection process according to the present embodiment. In the initial state in FIG. 6, it is assumed that the AP 1, and the BTs 3 and 4 have already been paired; information, such as a BDAddr, a Link key, and an APN setting, has been registered in the connection history DB 14; and the connection priority and a connection-permitted WLAN STA have been assigned to each BT device.

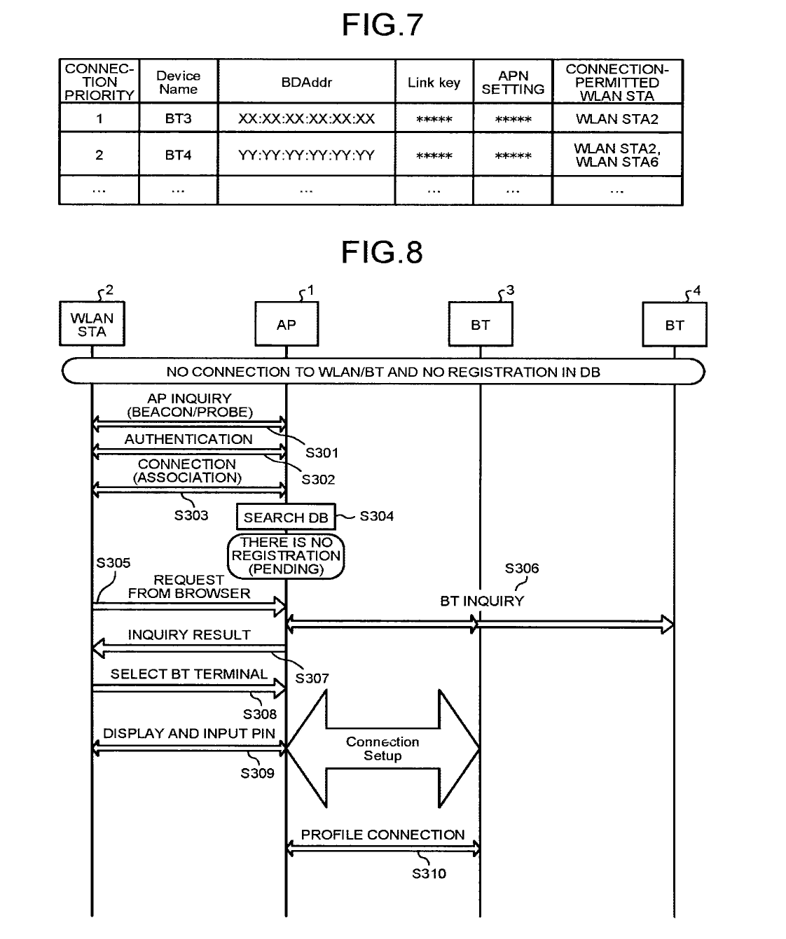

FIG. 7 illustrates a registration example of information registered in the connection history DB 14 according to the present embodiment. When compared with the items in the first embodiment (see FIG. 4), the item “connection-permitted WLAN STAs” is an addition. In this example, the BT 3 is permitted to connect to the WLAN STA 2, and the FT 4 is permitted to connect to the WLAN STA 2 and the WLAN STA 6.

That is, FIG. 7 illustrates that as a FT device to be used for communicating with an external network, the WLAN STA 2 can use the BTs 3 and 4, but the WLAN STA 6 can use only the BT 4.

In the initial state illustrated in FIG. 5, it is assumed that the connections of the AP 1, the WLAN STAs 2 and 6, and the BTs 3 and 4 are not established.

A specific network connection process is described below. The processes at Steps S201 to S203 are the same as the processes at Steps S101 to S103 in the first embodiment.

In the AP 1, having established a connection to the WLAN STA 2, the connection management unit 13 confirms whether there is a connection to an external network. When the AP is connected to the external network, the connection management unit 13 confirms whether a connected BT device, which is connected from the connection history DB 14, has permitted a connection to the WLAN STA 2. When the connection is permitted, the connection management unit 13 uses the established connection so as to provide a connection to the external network for the WLAN STA 2. When there is no connection to the external network, or when the connected BT device does not permit a connection for the WLAN STA 2, the connection management unit 13 in the AP 1 selects a connection-target BT device from the connection history DB 14. Because, in this example, the AP 1 is in a state where there is no connection to the external network, the connection management unit 13 searches for a connecting BT device from the connection history DB 14 (Step S204). In the AP 1, the connection management unit 13 selects the BT 3 as a first connection target because a connection to the WLAN STA 2 is permitted and also because the connection management unit 13 tries to connect to a BT device in the order of connection priority.

In the AP 1, the connection management unit 13 starts connecting to the ET 3 selected at Step S204 via the BT control unit 12 (Step S205). In this example, the AP 1 is assumed to have completed the connection to the BT 3.

In the AP 1, the connection management unit 13 executes a profile connection with the ET 3 connected to the AP 1 through the BT control unit 12 (Step S206). The connecting profile is the DUN, PAN, or the like that provides a connection to an external network. The connection management unit 13 obtains information required for a network connection from the connection history DB 14.

Next, the KLAN STA 6 that starts a connection to an external network inquires about a peripheral AP by receiving a Beacon transmitted from the AP 1 or by transmitting a Probe Request (Step S207).

The WLAN STA 6, having decided to connect to the AP 1 as a result of the inquiry at Step S207, performs an authentication process (Step S208) and a connection process (Step S209) to establish a connection between the KLAN STA 6 and the AP 1.

In the AP 1, having established a connection to the WLAN STA 6, the connection management unit 13 confirms whether there is a connection to an external network. Upon recognizing that the AP 1 is connected to the external network through the BT 3, the connection management unit 13 confirms with the connection history DB 14 whether the BT 3 permits a connection to the WLAN STA 6. Because in this example, the connection to the WLAN STA 6 is not permitted, the connection management unit 13 searches for a connecting BT device in the connection history DB 14 (Step S210). In the AP 1, the connection management unit 13 selects the BT 4 as a first connection target because the connection to the WLAN STA 6 is permitted and also because the connection management unit 13 attempts to connect to a BT device in the order of connection priority.

In the AP 1, the connection management unit 13 starts connecting to the BT 4 selected at Step S210 through the BT control unit 12 (Step S211). Here, the AP 1 is assumed to have completed the connection to the BT 4.

In the AP 1, the connection management unit 13 executes a profile connection with the BT 4 connected to the AP 1 via the BT control unit 12 (Step S212). The connecting profile is the DUN, PAN, or the like that provides a connection to an external network. The connection management unit 13 obtains information required for a network connection from the connection history DB 14.

The AP 1 connects to the WLAN STA 2 and to the BT 3, which is capable of communicating with the external network, so as to therefore be capable of providing communication with the external network via its own apparatus and the BT 3 to the WLAN STA 2. The WLAN STA 2 can communicate with the external network via the communication apparatus and the BT 3.

The AP 1 connects to the WLAN STA 6 and to the BT 4 capable of communicating with the external network and is therefore capable of providing communication with the external network via the own apparatus and the BT 4 to the WLAN STA 6. The WLAN STA 6 can communicate with the external network via the communication apparatus and the BT 4.

In the present embodiment, the BT 3 is used by the WLAN STA 2 to connect to the external network, and the BT 4 is used by the WLAN STA 6 to connect to the external network; while the BT 4 also permits a connection to the WLAN STA 2. Therefore, after the completion of a connection to the BT 4, the connection for the WLAN STA2 to the external network can be changed from the BT 3 to the BT 4; and therefore the connection with the BT 3 can be cut. By not restricting connection-permitted WLAN STAs, it is also possible to use a BT device for all the connected WLAN STAs to connect to an external network.

In a case where the AP 1 can handle a plurality of SSIDs (Service Set Identifiers), a BT device to be used for connecting to an external network can be selected on the basis of the SSID designated for the connection by a WLAN STA device. Further, the AP 1 can prepare a plurality of passphrases, and therefore it is also possible to select a FT device to be used for connecting to an external network on the basis of the passphrase used for the connection for a WLAN STA device.

The completion of a connection between a WLAN STA device and the AP 1 is one example of a trigger used to start connecting the AP 1 with a BT device. However, the present invention, similarly to the first embodiment, is not limited thereto. For example, message transmission and reception during the authentication process or the connection process can be used as a trigger to start connecting the AP 1 with the BT device; or when an Internet connection request from a browser or the like is issued, the AP 1 and the BT device can start connecting to each other.

When the connection of the AP 1 and the BT device has been completed, but only the profile connection has not yet been executed, then it is possible to omit the processes at Steps S205 and S211.

In the present embodiment, there has been described a case where there is no connection of the AP 1 and a BT device in the initial state. However, when there is a connection of the AP 1 and a BT device, the AP 1 can treat, similarly to the first embodiment, the connected BT device as a device with the highest connection priority. When their profiles are not compatible with each other, it is also possible for the connection management unit 13 in the AP 1 to search the connection history DB 14.

Connection priority assigned to a BT device can be set in advance by a user, or can be automatically determined and set by the AP 1 by registering the fee structure (such as a fixed fee or on an as-used basis) and the line information (such as 3G, LTE, or WiMAX), similarly to the first embodiment. By registering profile information supported by a BT device in the connection history DB 14, it is also possible to transmit a connection request only to a BT device that supports the DUN or PAN.

When a user operation such as inputting a PIN code is performed in a case, for example, where the Link key is deleted in a connection-target BT device, then the AP 1 can cancel the connection and select the next connection-target BT device, similarly to the first embodiment.

In the case where the AP 1 connects to a plurality of external-network connection devices, the AP 1 can connect to WLAN STAs in such a manner as to distribute loads on the basis of the traffic volume resulting from usage of each of the devices, the line information, the connection-permitted WLAN STAs, and other information.

The AP 1 has stored in advance in a DE the APN setting and other information required for connecting to an external network. This also makes it possible to automatically perform the APN setting suitable for each carrier on the basis of operator information obtained from an AT command or the like.

In the present embodiment, a BT-connected mobile phone has been described as an example of the external-network connection device. However, mobile phones in other connection modes such as a USE and a WLAN are also applicable.

As described above, the present embodiment makes it possible for an AP to change an external-network connection device connected to the AP in accordance with a WLAN STA connected to the AP. Therefore, in addition to the effects obtained from the first embodiment, the present embodiment can restrict use of a BT device by a non-permitted WLAN STA, and thus can prevent unintended billing, a connection made by a WLAN STA when used by another person, and other circumstances.

### Third Embodiment

In the present embodiment, a case is described where there is no connection history between the AP 1 and a BT device, and nothing is registered in the connection history DB 14. Parts different from those in the first embodiment are described.

The configuration of the communication network and the configuration of the AS 1 according to the present invention are identical to those illustrated in FIG. 1 and

FIG. 2, respectively.

Next, a network connection process in the AP 1 according to the present embodiment is described. FIG. 8 is a sequence diagram illustrating the network connection process according to the present embodiment. In the initial state illustrated in FIG. 8, it is assumed, as described previously, that there is no connection history between the AP 1 and the BTs 3 and 4, and nothing is registered in the connection history DB 14.

The processes at Steps S301 to S303 are the same as the processes at Steps S101 to S103 in the first embodiment.

In the AP 1 having established a connection to the WLAN STA 2, the connection management unit 13 confirms whether there is a connection to an external network. Upon confirming that there is no connection, further searching the connection history DB 14, and consequently confirming that a BT device is not registered, the connection management unit 13 suspends a request pending from the WLAN STA 2 to an external network (Step S304).

The WLAN STA 2 starts-up a browser in order to connect to an external network and transmits a request message to the AP 1 (Step S305). The AP 1 determines whether the request message is a request from the browser on the basis of the packet TCP header information and the like.

In the AP 1 that has received the request from the WLAN STA 2, the connection management unit 13 temporarily suspends the request from the WLAN STA 2 and starts inquiring about a peripheral BT device via the BT control unit 12 (Step S306).

Upon finishing the ST-device inquiry, the connection management unit 13 in the AP 1 converts the obtained BT-device inquiry results into a form that can be displayed in a Web browser and returns the converted inquiry results as a reply message to the WLAN STA 2 via the WLAN control unit 11 (Step S307). The WLAN STA 2 displays the BT-device inquiry results in the browser.

The WLAN STA 2 selects its desired connecting BT device (the BT 3 in this example) from the list of BT devices displayed by the browser (Step S308).

The connection management unit 13 in the AP 1 performs a pairing process with the BT device (the BT 3) selected at Step S308. When it is necessary to input and display a PIN code, the connection management unit 13 converts the PIN code into a form that can be displayed in the Web browser and transmits the converted PIN code to the WLAN STA 2 via the WLAN control unit 11. Therefore, the connection management unit 13 in the AP 1 displays this PIN code in the browser of the WLAN STA 2 and instructs the inputting process. The connection management unit 13 in the AP 1 uses the obtained information to continue the pairing (Step S309). The basic operations of the pairing are based on the “Bluetooth, “Specification of Bluetooth System Covered Core Package Version: 4.0”, 30 Jun. 2010”. However, the version of Bluetooth and the like are not specifically limited thereto as long as being able to connect to the BT 3 illustrated in FIG. 8.

In the AP 1, the connection management unit 13 executes a profile connection with the BT 3 connected thereto via the BT control unit 12 (Step S310).

The AP 1 connects to the WLAN STA 2 and to the ST 3 capable of communicating with an external network and is therefore capable of providing communication with the external network via its own apparatus and the BT 3 to the WLAN STA 2. The WLAN STA 2 can communicate with the external network via the communication apparatus and the BT 3.

In the present embodiment, at Step S307, a WLAN STA device displays all the BT inquiry results. However, the WLAN STA device can obtain BT-device support profile information according to the SDP (Service Discovery Protocol) and can display only a BT device that supports the DUN or PAN. Further, in a case where another profile such as an HFP (Hands Free Profile) has been already connected to a BT device, and thus simultaneous connection to the DUN or PAN cannot be provided, the WLAN STA device is still capable of displaying a message in the browser. In this case, the AP 1 notifies the WLAN STA device that simultaneous connections cannot be provided.

Note that the AP 1 has stored in advance in a DB the APN setting and other information required for connecting to an external network, which also makes it possible to automatically perform the APN setting suitable for each carrier on the basis of operator information obtained from an AT command or the like.

In the present embodiment, a BT-connected mobile phone has been described as an example of the external-network connection device. However, similarly to the first embodiment, this is also applicable to WLAN-connected devices and other devices in which input for device selection, a PIN code input or the like at the time of authentication are needed.

In the present embodiment, the AP 1 transmits and receives information via the browser of the WLAN STA device. However, the present invention is not limited thereto. Using a specific application or using a sound input from a speaker or a microphone is also possible.

As described above, according to the present embodiment, in the network configuration in which an AP connects to an external network via another device, when the AP connects to an external-network connection device that is not registered in the connection history, information required for the authentication of the connection of the AP and the external-network connection device is displayed in a browser of a WLAN STA. Therefore, a user can continue the connection process by operating the WLAN STA without the need of an AP operation.

When BT-device inquiry results are displayed when connecting to a BT device, filtering of these results using profile information in the AP can prevent a BT device, which does not have a function of connecting to an external network, from being displayed to a user.

### INDUSTRIAL APPLICABILITY

As described above, the communication apparatus according to the present invention is useful for wireless communication, and it is particularly suitable for an apparatus capable of providing a connection to an external network.

### REFERENCE SIGNS LIST

1 AP, 2, 6 WLAN STA, 3, 4 BT, 5 base station, WLAN control unit, 12 BT control unit, 13 connection management unit, 14 connection history DB.

1. A communication apparatus comprising:
a first communication-control unit that uses a first communication mode to communicate with a first communication device that is to communicate with an external network;
a second communication-control unit that uses a second communication mode to communicate with a second communication device that is capable of communicating with the external network;
a connection-history storage unit that stores therein information on a connection to the second communication device and order of priority for connecting to the second communication device; and
a connection management unit that refers to the connection-history storage unit to manage a connection to the first communication device and a connection to the second communication device, wherein
the communication apparatus
connects to the first communication device and to the second communication device, and
enables the first communication device to communicate with the external network via the own apparatus and the second communication device, and
the connection-history storage unit stores therein information on the first communication devices that the second communication device permits to be used as the second communication device to be used when the first communication device communicates with the external network.

2. The communication apparatus according to claim 1, wherein
the connection management unit starts a connection process to the second communication device by a transmission or a reception of a message, as a trigger, at the connection to the first communication device.

3. The communication apparatus according to claim 1, wherein
the connection management unit starts a connection process to the second communication device upon the first communication device accessing the external network as a trigger.

4. The communication apparatus according to claim 1, wherein
the connection management unit automatically sets connection priority by using at least one piece of information among line information and a fee structure when using the second communication device.

5. The communication apparatus according to claim 1, wherein
when the connection-history storage unit stores profile information that is compatible with the second communication device therein,
the connection management unit performs a connection process with the second communication device that has a profile for connecting to the external network.

6. (canceled)

7. The communication apparatus according to claim 1, wherein
in a case where the communication apparatus can connect to first communication devices A and B that serve as the first communication device and can connect to second communication devices A and B that serve as the second communication device,
when the second communication device A is used for communication to the first communication device A; the second communication device B is used for communication to the first communication device B; and the second communication device B permits also the first communication device A to be used,
the connection management unit
cancels a connection to the second communication device A; and
uses the second communication device B to communicate with the external network for the first communication device A.

8. The communication apparatus according to claim 1, wherein
when the connection management unit can handle a plurality of SSIDs (Service Set Identifiers), the connection management unit selects the second communication device to be used on the basis of an SSID designated by the first communication device.

9. The communication apparatus according to claim 1, wherein
when the connection management unit can handle a plurality of passphrases, the connection management unit selects the second communication device to be used on the basis of a passphrase designated by the first communication device.

10. The communication apparatus according to claim 1, wherein
when the connection management unit connects to a plurality of the second communication devices, the connection management unit connects to the first communication devices in such a manner as to distribute loads by using at least one piece of information among traffic volume by the usage of each of the second communication devices, line information, and information on the first communication device to which connection is permitted.

11-17. (canceled)

18. The communication apparatus according to claim 1, wherein
when the communication apparatus further comprises a storage unit that has stored therein an APN (Access Point Network) setting required for connecting to the external network,
the connection management unit automatically sets the APN setting suitable for each carrier on the basis of operator information obtained from an AT command.

19. A network connection method in a communication apparatus that connects to a first communication device and to a second communication device, where the communication apparatus includes a connection-history storage unit that stores therein information on a connection to the second communication device and order of priority for connecting to the second communication device,
the network connection method comprising:
a first communication-controlling step of using a first communication mode to communicate with the first communication device that desires communication with an external network;
a second communication-controlling step of using a second communication mode to communicate with the second communication device that can communicate with the external network;
a connection managing step of referring to the connection-history storage unit to manage a connection to the first communication device and a connection to the second communication device; and
an external-network communicating step of
connecting to the first communication device and to the second communication device, and
enabling the first communication device to communicate with the external network via the own apparatus and the second communication device, and
the connection-history storage unit stores therein information on the first communication devices which the second communication device permits to be used as the second communication device to be used when the first communication device communicates with the external network.

20. The network connection method according to claim 19, wherein
at the connection managing step, the connection to the second communication device starts by a transmission or reception of a message, as a trigger, at the connection to the first communication device.

21. The network connection method according to claim 19, wherein
at the connection managing step, the connection to the second communication device starts upon the first communication device accessing the external network as a trigger.

22. The network connection method according to claim 19, wherein
at the connection managing step, connection priority automatically is set by using at least one piece of information among line information and a fee structure when using the second communication device.

23. The network connection method according to claim 19, wherein
when the connection-history storage unit stores therein profile information that is compatible with the second communication device,
at the connection managing step, a connection process is performed with the second communication device that has a profile for connecting to the external network.

24. (canceled)

25. The network connection method according to claim 19, wherein
in a case where the communication apparatus can connect to first communication devices A and B that serve as the first communication device and can connect to second communication devices A and B that serve as the second communication device,
at the connection managing step,
when the second communication device A is used for communication to the first communication device A; the second communication device B is used for communication to the first communication device B; and the second communication device B also permits the use of the first communication device A,
a connection to the second communication device A is cancelled; and
the second communication device B is used to communicate with the external network for the first communication device A.

26. The network connection method according to claim 19, wherein
at the connection managing step, when the communication apparatus can handle a plurality of SSIDs (Service Set Identifiers),
the second communication device to be used is selected on the basis of an SSID designated by the first communication device.

27. The network connection method according to claim 19, wherein at the connection managing step,
when the communication apparatus can handle a plurality of passphrases, the second communication device to be used is selected on the basis of a passphrase designated by the first communication device.

28. The network connection method according to claim 19, wherein at the connection managing step,
when the communication apparatus connects to a plurality of second communication devices, the communication apparatus connects to the first communication devices in such a manner as to distribute loads by using at least one piece of information among a traffic volume according to the usage of each of the second communication devices, line information, and information on the first communication device to which connection is permitted.

29-35. (canceled)

36. The network connection method according to claim 19, wherein
when the communication apparatus further includes a storage unit that has stored therein an APN (Access Point Network) setting required for connecting to the external network,
at the connection managing step, the APN setting suitable for each carrier is automatically set on the basis of operator information obtained from an AT command.
